(19) United States
(12) Patent Application Publication
(10) Pub. No.: US 2023/0326191 A1
(43) Pub. Date: Oct. 12, 2023

(54) Method and Apparatus for Enhancing Performance of Machine Learning Classification Task

(71) Applicant: Siemens Aktiengesellschaft, München (DE)

(72) Inventors: Xiang Li, Beijing (CN); Avinash Kumar, München (DE); Ralf Gross, Nürnberg (DE); Xiao Feng Wang, Beijing (CN); Matthias Loskyll, Neumarkt (DE)

(73) Assignee: Siemens Aktiengesellschaft, München (DE)

(21) Appl. No.: 18/041,957

(22) PCT Filed: Aug. 17, 2020
(86) PCT No.: PCT/CN2020/109601

§ 371 Date: Feb. 16, 2023

(51) Int. Cl. G06V 10/776; G06V 10/77

(52) U.S. Cl. CPC G06V 10/776; G06V 10/7715

(57) ABSTRACT

Various embodiments of the teachings herein include methods and/or systems for enhancing performance of a machine learning (ML) classification task. An example method includes: obtaining a first prediction generated by a first ML classification model provided with production data as input; obtaining a second prediction generated by a second ML classification model provided with the production data as input; and determining a prediction result for the production data by calculating a weighted sum of the first prediction and the second prediction based on weights for the first ML classification model and the second ML classification model. The first ML classification model comprises a few-shot learning model having a first feature extractor followed by a metric-based classifier. The second ML classification model has a second feature extractor followed by a fully-connected classifier.

### CROSS-REFERENCE TO RELATED APPLICATIONS

This application is a U.S. National Stage Application of International Application No. PCT/CN2020/109601 filed Aug. 17, 2020, which designates the United States of America, the contents of which are hereby incorporated by reference in their entirety.

### TECHNICAL FIELD

The present disclosure generally relates to machine learning. Various embodiments of the teachings herein include methods and/or systems for enhancing the performance of a machine learning classification task.

### BACKGROUND

Machine learning (ML), as a subset of artificial intelligence (AI), involves computers learning from data to make predictions or decisions without being explicitly programmed to do so, and it has been experiencing tremendous growth in recent years, with the substantial increase of powerful computing capability, the development of advanced algorithms and models, and the availability of big data. Classification is one of the most common tasks to which machine learning techniques are applied, and nowadays various machine learning classification models are being used in a wide variety of applications, even for the industrial sectors. For example, the usage of classification models has greatly improved the efficiency of many operations such as quality inspection, process control, anomaly detection, and so on, facilitating the rapid progress of industrial automation.

### SUMMARY

This summary is provided to introduce a selection of concepts in a simplified form that are further described below in the detailed description. This summary is not intended to identify any key features or essential features of the claimed subject matter, nor is it intended to be used as an aid in determining the scope of the claimed subject matter.

As an example, some embodiments of the teachings described herein include a method for enhancing performance of a machine learning classification task, comprising: obtaining a first prediction outputted by a first machine learning (ML) classification model which is provided with production data as the input, wherein the first ML classification model is a few-shot learning model having a first feature extractor followed by a metric-based classifier; obtaining a second prediction outputted by a second ML classification model which is provided with the production data as the input, wherein the second ML classification model has a second feature extractor followed by a fully-connected classifier; and determining a prediction result for the production data by calculating a weighted sum of the first prediction and the second prediction based on weights for the first ML classification model and the second ML classification model.

In some embodiments, the weights for the first ML classification model and the second ML classification model are each determined based on a performance score for the first ML classification model and a performance score for the second ML classification model that are both evaluated using the same set of test data.

In some embodiments, in determining of the weights for the first ML classification model and the second ML classification model, a hyper-parameter is used to control amplifying rate of difference between the performance score for the first ML classification model and the performance score for the second ML classification model.

In some embodiments, one or more parameters of the first feature extractor of the first ML classification model are to be shared with the second feature extractor of the second ML classification model, after training of the first ML classification model.

In some embodiments, a momentum is used to control a ratio of each of the shared parameters of the first feature extractor of the trained first ML classification model to be adopted by the second feature extractor of the second ML classification model.

In some embodiments, a fine tuning action is to be performed on the second ML classification model, after the one or more parameters of the first feature extractor of the trained first ML classification model are shared with the second feature extractor of the second ML classification model.

In some embodiments, the first ML classification model is trained on a regular basis in an incremental manner, and wherein the production data comprises image data.

As another example, some embodiments include a computing device comprising: memory for storing instructions; and one or more processing units coupled to the memory, wherein the instructions, when executed by the one or more processing units, cause the one or more processing units to: obtain a first prediction outputted by a first machine learning (ML) classification model which is provided with production data as the input, wherein the first ML classification model is a few-shot learning model having a first feature extractor followed by a metric-based classifier; obtain a second prediction outputted by a second ML classification model which is provided with the production data as the input, wherein the second ML classification model has a second feature extractor followed by a fully-connected classifier; and determine a prediction result for the production data by calculating a weighted sum of the first prediction and the second prediction based on weights for the first ML classification model and the second ML classification model.

In some embodiments, the weights for the first ML classification model and the second ML classification model are each determined based on a performance score for the first ML classification model and a performance score for the second ML classification model that are both evaluated using the same set of test data.

In some embodiments, in determining of the weights for the first ML classification model and the second ML classification model, a hyper-parameter is used to control amplifying rate of difference between the performance score for the first ML classification model and the performance score for the second ML classification model.

In some embodiments, one or more parameters of the first feature extractor of the first ML classification model are to be shared with the second feature extractor of the second ML classification model, after training of the first ML classification model.

In some embodiments, a momentum is used to control a ratio of each of the shared parameters of the first feature extractor of the trained first ML classification model to be adopted by the second feature extractor of the second ML classification model.

In some embodiments, a fine tuning action is to be performed on the second ML classification model, after the one or more parameters of the first feature extractor of the trained first ML classification model are shared with the second feature extractor of the second ML classification model.

In some embodiments, the first ML classification model is trained on a regular basis in an incremental manner, and wherein the production data comprises image data.

As another example, some embodiments include a non-transitory computer-readable storage medium having stored thereon instructions that, when executed on one or more processing units, cause the one or more processing units to: obtain a first prediction outputted by a first machine learning (ML) classification model which is provided with production data as the input, wherein the first ML classification model is a few-shot learning model having a first feature extractor followed by a metric-based classifier; obtain a second prediction outputted by a second ML classification model which is provided with the production data as the input, wherein the second ML classification model has a second feature extractor followed by a fully-connected classifier; and determine a prediction result for the production data by calculating a weighted sum of the first prediction and the second prediction based on weights for the first ML classification model and the second ML classification model.

In some embodiments, the weights for the first ML classification model and the second ML classification model are each determined based on a performance score for the first ML classification model and a performance score for the second ML classification model that are both evaluated using the same set of test data.

In some embodiments, in determining of the weights for the first ML classification model and the second ML classification model, a hyper-parameter is used to control amplifying rate of difference between the performance score for the first ML classification model and the performance score for the second ML classification model.

In some embodiments, one or more parameters of the first feature extractor of the first ML classification model are to be shared with the second feature extractor of the second ML classification model, after training of the first ML classification model.

In some embodiments, a momentum is used to control a ratio of each of the shared parameters of the first feature extractor of the shared first ML classification model to be adopted by the second feature extractor of the second ML classification model.

As another example, some embodiments include an apparatus for enhancing performance of a machine learning classification task, comprising means for performing one or more of the methods as described herein.

### BRIEF DESCRIPTION OF THE DRAWINGS

Embodiments of the present disclosure are illustrated by way of example, and not by way of limitation, in the figures of the accompanying drawings in which like references numerals refers to identical or similar elements and in which:

FIG. 1 is an exemplary performance change curve chart incorporating teachings of the present disclosure;

FIGS. 2A and 2B illustrating exemplary high-level structures of machine learning classification models incorporating teachings of the present disclosure;

FIG. 3 is a flow chart of an exemplary method incorporating teachings of the present disclosure;

FIG. 4 is an exemplary performance change curve chart incorporating teachings of the present disclosure;

FIG. 5 illustrates an exemplary overall process incorporating teachings of the present disclosure;

FIG. 6 is a block diagram of an exemplary apparatus incorporating teachings of the present disclosure; and

FIG. 7 is a block diagram of an exemplary computing device incorporating teachings of the present disclosure.

### REFERENCE NUMERAL LIST

310: obtaining a first prediction outputted by a first machine
learning classification model
320: obtaining a second prediction outputted by a second
machine learning classification model
330: determining a prediction result by calculating a weighted
sum of the first and second predictions
510: model training stage
520: performance evaluation stage
530: model application stage
610-630: modules
710: one or more processing units
720: memory

### DETAILED DESCRIPTION

In some embodiments of the teachings herein, a method for enhancing performance of a machine learning classification task comprises: obtaining a first prediction outputted by a first machine learning (ML) classification model which is provided with production data as the input, wherein the first ML classification model is a few-shot learning model having a first feature extractor followed by a metric-based classifier; obtaining a second prediction outputted by a second ML classification model which is provided with the production data as the input, wherein the second ML classification model has a second feature extractor followed by a fully-connected classifier; and determining a prediction result for the production data by calculating a weighted sum of the first prediction and the second prediction based on weights for the first ML classification model and the second ML classification model.

In some embodiments, a computing device comprises: memory for storing instructions; and one or more processing units coupled to the memory, wherein the instructions, when executed by the one or more processing units, cause the one or more processing units to: obtain a first prediction outputted by a first machine learning (ML) classification model which is provided with production data as the input, wherein the first ML classification model is a few-shot learning model having a first feature extractor followed by a metric-based classifier; obtain a second prediction outputted by a second ML classification model which is provided with the production data as the input, wherein the second ML classification model has a second feature extractor followed by a fully-connected classifier; and determine a prediction result for the production data by calculating a weighted sum of the first prediction and the second prediction based on weights for the first ML classification model and the second ML classification model.

In some embodiments, a non-transitory computer-readable storage medium has stored thereon instructions that, when executed on one or more processing units, cause the one or more processing units to obtain a first prediction outputted by a first machine learning (ML) classification model which is provided with production data as the input, wherein the first ML classification model is a few-shot learning model having a first feature extractor followed by a metric-based classifier; obtain a second prediction outputted by a second ML classification model which is provided with the production data as the input, wherein the second ML classification model has a second feature extractor followed by a fully-connected classifier; and determine a prediction result for the production data by calculating a weighted sum of the first prediction and the second prediction based on weights for the first ML classification model and the second ML classification model.

In some embodiments, an apparatus for enhancing performance of a machine learning classification task comprises: means for obtaining a first prediction outputted by a first machine learning (ML) classification model which is provided with production data as the input, wherein the first ML classification model is a few-shot learning model having a first feature extractor followed by a metric-based classifier; means for obtaining a second prediction outputted by a second ML classification model which is provided with the production data as the input, wherein the second ML classification model has a second feature extractor followed by a fully-connected classifier; and means for determining a prediction result for the production data by calculating a weighted sum of the first prediction and the second prediction based on weights for the first ML classification model and the second ML classification model.

In the following description, numerous specific details are set forth for the purposes of explanation. It should be understood that, however, embodiments of the present disclosure may be practiced without these specific details. In other instances, well-known circuits, structures and techniques have not been shown in detail in order not to obscure the understanding of the disclosure.

References to “one embodiment”, “an embodiment”, “exemplary embodiment”, “some embodiments”, “various embodiments” or the like throughout the description indicate that the embodiment(s) of the present disclosure so described may include particular features, structures or characteristics, but it is not necessarily for every embodiment to include the particular features, structures or characteristics. Further, some embodiments may have some, all or none of the features described for other embodiments.

In the following description and claims, the terms “coupled” and “connected”, along with their derivatives, may be used. It should be understood that these terms are not intended as synonyms for each other. Rather, in particular embodiments, “connected” is used to indicate that two or more elements are indirect physical or electrical contact with each other, while “coupled” is used to indicate that two or more elements co-operate or interact with each other, but they may or may not be in direct physical or electrical contact.

Machine learning (ML) classification algorithms and models have been used in a wide variety of applications, including industrial applications. Currently, for most of classification tasks, a machine learning classification model with a fully-connected classifier (hereinafter also referred to as “FC model”) is a go-to option because of its proven performance and usability. A typical and non-limiting example of such a FC model is convolutional neural network (CNN), which has demonstrated its amazing performance in many classification tasks, including but not limited to image classification.

One downside of FC models is that the training process of a FC model usually demands a large amount of training data in order to achieve good performance. However, inmost cases, the amount of data collected grows along with the time span of data collection of a corresponding industrial process. For factories where machine learning is to be deployed, it is often the case that the factories just start to collect and store the production data when they intend to start machine learning projects. So, what happens frequently is that at the beginning of an industrial machine learning project, there isn't enough data volume to be used as training data to train a well-performed FC model. Few-shot learning (FSL) algorithms such as Siamese Network, Relational Network, and Prototypical Network are adopted to resolve this problem by delivering good performance with only a limited amount of data, which may be as few as one sample per class, due to its capability to rapidly generalize to anew task where few samples are available, by using prior knowledge.

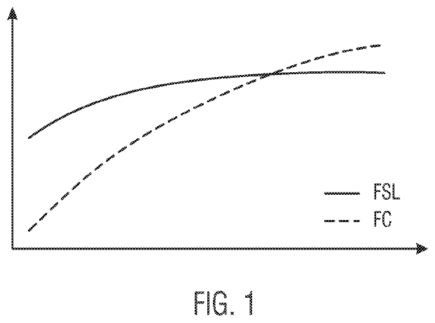

FIG. 1 is a chart illustrating exemplary performance change curves of a FSL model and a FC model, incorporating teachings of the present disclosure, where the vertical axis represents performance while the horizontal axis represents data volume for training. In this figure, the dash curve shows the performance change curve for the FC model, where the performance goes up gradually as the data volume increases. In contrast, the solid curve demonstrates the strength of the FSL model when the data volume is low, however, the FSL model has a lower performance ceiling in the long run.

Another plus of FSL models is that they are flexible with new classes, meaning that new class(es) can be added to recognize without much effort. For example, for a defect detection process in a factory where machine learning-based image classification is used to identify classes of the defects found from the captured images of products produced/assembled on a product line, there may be the case that the classes of defects are not fixed. Instead, one or mode new types of defects may emerge due to change of process, improved detection capability, and etc., and thus also need to be recognized. So FSL models are especially useful in this and similar scenarios. On the contrary, FC models are usually of a fixed size, and to add new class (es) to recognize requires retraining with large data volume, which is time and computation costly.

Various embodiments of the teachings herein can benefit from both a FSL model which is flexible in terms of class number and delivers good performance with few data at the beginning, and a FC model which has a higher performance ceiling in the long run.

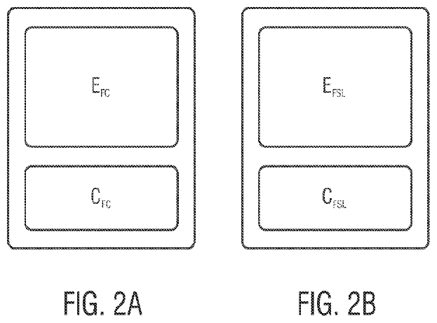

FIGS. 2A and 2B illustrates exemplary high-level structures of a FC model and a FSL model, incorporating teachings of the present disclosure. A machine learning classification model generally comprises a feature extractor followed by a classifier. As shown in FIG. 2A, an exemplary FC model may comprise a feature extractor EFC to extract features from the input data, and a fully-connected classifier CFC to predict classification for the input data based on the extracted features. Here, as a non-limiting example, the input data may refer to an image to be recognized, although the present disclosure should not be limited in this respect. For a CNN which is a typical example of a FC model, a stack of convolutional layers and pooling layers in the network can be considered as the feature extractor thereof, while the last fully-connected layer, which generally adopts a softmax function as the activation function, can be regarded as the classifier. “Fully-connected” means that all nodes in the layer are fully connected to all the nodes in the previous layer, which produces a complex model to explore all possible connections among nodes. So, all the features extracted in the previous layers are merged in the fully-connected layer. Softmax is used to map the non-normalized output of a network to a probability distribution over predicted output classes.

FIG. 2B shows the high-level structure of an exemplary FSL model. The main difference between the FSL model and the FC model lies in the downstream modules. More specifically, the FSL model is equipped with a metric-based classifier, denoted herein by CFSL. Compared with the fully-connected classifier CFC used in the FC model which has a large amount of parameters that need to be optimized by using the large training data volume, the metric-based classifier CFSL used in the FSL model adopts distance, similarity, or the like as the metric, and it is easy to add new classes to recognize and can effectively avoid overfitting which may be caused by fewer training samples, so the metric-based classifier is more suitable for the learning paradigm of few-shot learning. As to the feature extractor of the FSL model, denoted herein by EFSL, it may have the same or similar architecture as that of the FC model, according to some embodiments. However, it could be readily appreciated that the present disclosure is be limited in this respect.

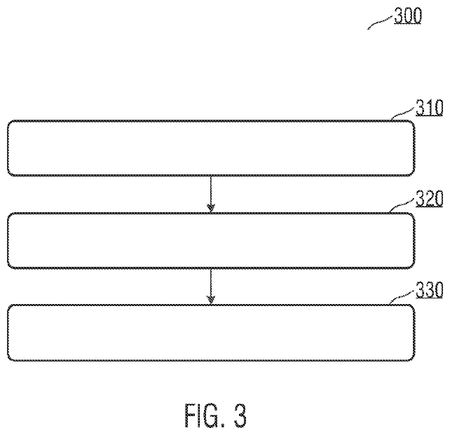

By referring to FIG. 3, a flow chart of an exemplary method 300 incorporating teachings of the present disclosure, which is to improve performance of a machine learning classification task by integrating a FSL model and a FC model, will be described.

As illustrated in FIG. 3, the exemplary method 300 begins with step 310, where a first prediction outputted by a first ML classification model is obtained, wherein the first ML classification model is provided with production data as the input, and wherein the first ML classification model is a few-shot learning model (i.e., a FSL model as discussed above) having a first feature extractor (i.e., EFSL) followed by a metric-based classifier (i.e., CFSL).

In some embodiments, the teachings may be deployed in a factory where computer vision and machine learning techniques are adopted to implement an automatic sorting system. Specifically, there may be a number of types/classes of products, components or items that need to be recognized and sorted. For each of the products, components or items, an imaging device such as a camera or the like may capture an image thereof, as the production data. The imaging device may be coupled to a computing device, examples of which may include but not limited to a personal computer, a workstation, a server, and etc. The captured image data, after being pre-processed if necessary, may be transmitted to the computing device where machine learning classification models including the FSL model are running, and is thus provided as the input to the FSL model, which then outputs the first prediction indicating a probability distribution over the defined classes. For example, for an item which might belong to one of three defined classes A, B, C, the prediction may indicate a probability of 0.6 of class A, a probability of 0.3 of class B, and a probability of 0.1 of class C. In other words, the FSL model predicts this item is of class A, because of the highest probability of 0.6 among the three. It should be noted that, however, this prediction may not conform to the ground truth of the particular item, as the FSL model may not always have good performance, especially considering a long-run situation. The first prediction from the FSL model is thus obtained, by the computing device, for further processing as discussed below in detail.

In step 320, a second prediction outputted by a second ML classification model is obtained. Here, the production data provided to the FSL model, which for example is an image of an item as described above, is also provided as the input to the second ML classification model (i.e. a FC model as discussed above) which has a second feature extractor (i.e., EFC) followed by a fully-connected classifier (i.e., CFC). The FC model may run on the computing device as well. According to some embodiments of the disclosure, the FC model may comprise a convolutional neural network (CNN), wherein the EFC may correspond to the stack of convolutional layer and pooling layers in the CNN, while the CFC may correspond to the last fully-connected layer with a softmax function as the activation function in the CNN, although the present disclosure is not limited in this respect. Examples of CNN may include but not limited to LeNet, AlexNet, VGG-Net, GoogLeNet, ResNet, and etc. Still referring to the above example discussed with step 310, the second prediction from the FC model obtained at step 320 may indicate a probability of 0.1 of class A, a probability of 0.4 of class B, and a probability of 0.5 of class C, for that particular item. That is, the FC model predicts this item is of class C, because of the highest probability of 0.5 among the three. However, the second prediction may not be true, either. The second prediction from the FC model is thus obtained, by the computing device, for further processing as discussed below in detail.

Then the method 300 proceeds to step 330. In this step, a prediction result for the production data is determined by calculating a weighted sum of the first prediction and the second prediction based on weights for the first ML classification model and the second ML classification model. Instead of using a prediction from a single model as the final result, a prediction voting mechanism is proposed herein, to integrate the both predictions from the FSL model and the FC model in order to provide better performance, meanwhile the flexibility on class number of FSL model is also preserved.

In some embodiments, in the voting mechanism disclosed herein, the weights for the FSL model and the FC model are each determined based on a performance score for the FSL mode and a performance score for the FC model, and the performance scores are both evaluated using the same set of test data, according to some embodiments of the disclosure. In some embodiments, for each of the models, the evaluation of performance score is performed after the model is trained/re-trained.

The performance score of a model may be evaluated in different ways. In some embodiments, accuracy calculated for a model on the test data set may be used as the performance score for that model. Other metrics, such as precision, recall, or F1-Score which could be readily appreciated by those skilled in the art, are also possible for the performance score, and the present disclosure is not limited in this respect.

Based on the same set of test data, the performance scores evaluated for the two models are comparable, and can be used to determine a weight for each of the models by choosing a proper algorithm. In some embodiments, a logistic weighted sum of the predictions from the two models may be calculated using the following equation:

$$y = \frac{{e}^{τ * {s}_{F S L}}}{{e}^{τ * {s}_{F S L}} + {e}^{τ * {s}_{F C}}} * {y}_{F S L} + \frac{{e}^{τ * {s}_{F C}}}{{e}^{τ * {s}_{F S L}} + {e}^{τ * {s}_{F C}}} * {y}_{F C} \qquad ( Equation 1 )$$

where y_{FSL} is the prediction of the FSL model, y_{FC} is the prediction of the FC model, and y is the integrated prediction of the two models. In this equation,

$$\frac{{e}^{τ * {s}_{F S L}}}{{e}^{τ * {s}_{F S L}} + {e}^{τ * {s}_{F C}}}$$

represents the weight for the FSL model, and

$$\frac{{e}^{τ * {s}_{FC}}}{{e}^{τ * {s}_{F S L}} + {e}^{τ * {s}_{F C}}}$$

represents the weight for the FC model, where e is the base of the natural logarithm, also known as Euler's number, s_{FSL} is the performance score of the FSL model, s_{FC} is the performance score of the FC model, and τ is a hyper-parameter which controls the amplifying rate of difference between s_{FC} and s_{FSL}, wherein τ is a real number and τ>0. The larger the value of τ is, the greater influence a performance score will have on its voting capability. It could be readily appreciated that other algorithms are also possible to determine weights and accordingly to calculate the prediction result.

Stilly referring to the example discussed above with regard to steps 310 and 320, shown below is a prediction result y calculated using the manner disclosed herein, assuming s_{FC}=95%, s_{FSL}=90%, and τ=1. For this example shown in Table 1 where there are three classes (A, B, C) need to recognize, it can be seen that if the FSL model is used solely, or if the FC model is used solely, a false prediction will be produced. More particularly, the prediction from the FSL model indicates class A having the highest probability of 0.600, while the prediction from the FC model indicates class C having the highest probability of 0.500. But actually, class B is the ground truth for that particular item in this example. With the voting mechanism disclosed herein, however, the correct answer can be acquired out of the two false predictions.

TABLE 1
Prediction Voting Example
s_{FC} = 95%, s_{FSL} = 90%, τ = 1

| | | Probability | |
|---|---|---|---|
| | | of B | |
| | Probability | (ground | Probability |
| | of A | truth) | of C |
| y_{FSL} | 0.600 | 0.300 | 0.100 |
| y_{FC} | 0.100 | 0.400 | 0.500 |
| y | 0.344 | 0.351 | 0.305 |

By integrating the FSL model and the FC model using the prediction voting mechanism disclosed herein, the advantageous aspects of the both models, including good performance even for low data volume for the FSL model, and high performance ceiling in the long run for the FC model, can be obtained to achieve better performance, meanwhile preserving the flexibility of the FSL model to recognize new classes, which is especially helpful in many scenarios.

It should be noted that the sequence from step 310 to step 330 as discussed above does not mean, in any way, that the exemplary method 300 can only be performed in this sequential order. Instead, it could be readily appreciated that some of the operations may be performed simultaneously, in parallel, or in a different order. As an example, steps 310 and 320 may be performed simultaneously.

In some embodiments, the method 300 may further comprise outputting, by the computing device, a message indicating the prediction result determined in step 330. And in some embodiments, the message thus outputted may be taken as a trigger to control other electrical and/or mechanical equipment(s) to implement automatic sorting of the particular item.

While in the above discussion the exemplary method 300 is performed on a single computing device, it could be readily appreciated that these steps may also be performed on different devices. According to some embodiments of the disclosure, the method 300 may be implemented in a distributing computing environment. In some embodiments, the method 300 may be implemented using cloud-computing technologies, although the present disclosure is not limited in this respect.

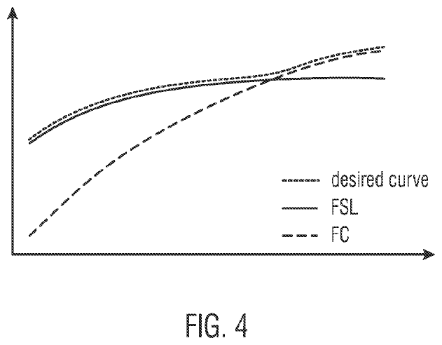

Turning now to FIG. 4, an exemplary performance change curve chart incorporating teachings of the present disclosure is illustrated. FIG. 4 is similar to FIG. 1, except that it further illustrates a desired performance change curve that can be achieved using the prediction voting mechanism disclosed herein, denoted herein by the dot curve. As illustrated, the prediction voting mechanism generally follows the performance change curve of the FSL model before the intersection point of the curves of the two models, meaning that it has good performance even with low data volume at an earlier phase; while at or near the intersection point, it transitions to follow the curve of the FC model generally, meaning that it will have a higher performance ceiling in a long run.

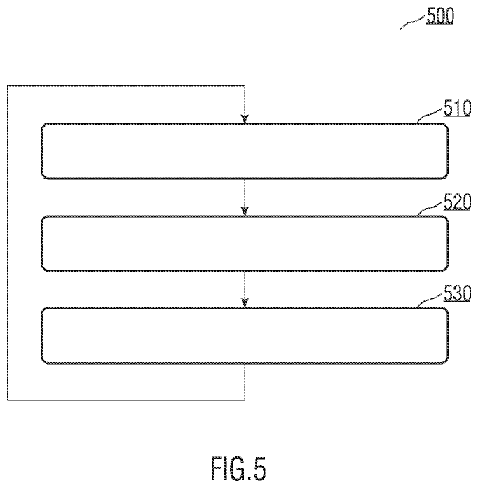

FIG. 5 illustrates an exemplary overall process 500 in accordance with some embodiments of the disclosure. The overall process 500 may comprise a model training stage 510, a performance evaluation stage 520, and a model application stage 530.

In the model training stage 510, the FSL model and the FC model are trained, before the models are put into use. After training, performance scores of the trained models are evaluated respectively using the same set of test data, as discussed before, in the performance evaluation stage 520. Then, in the model application stage 530, the operations discussed with reference to the exemplary method 300 are performed, to integrate the FSL model and the FC model using the prediction voting mechanism disclosed herein.

As illustrated in FIG. 5, the overall process 500 including the three stages 510-530 may be performed in an iterative way, according to some embodiments of the disclosure. It should also be noted that for each of the iterations, the test data set used in the performance evaluation stage 520 and/or the hyper-parameter τ used in the model application stage 530 for the current iteration may, or may not be the same as those used in a previous iteration.

In some embodiments, the overall process 500 may jump, on a regular basis, from the model application stage 530 back to the model training stage 510 to launch re-training of the models. In some embodiments, one or more of the models are trained in an incremental manner. That is, the training is performed on the current model with new training data, which for example may be collected during the model application stage 530 in the previous iteration, to further optimize parameters of the current model.

In some embodiments, the feature extractor of the FSL model (i.e., EFSL in FIG. 2B) may have the same or similar architecture as the feature extractor of the FC model (i.e., EFC in FIG. 2A), and accordingly it is possible for them to share one or more parameters. In some embodiments, in every iteration the training of the FSL model, which for example is performed in an incremental manner as discussed above, may trigger a parameter sharing process in the model training stage 510, in which one or more parameters of EFSL of the trained FSL model are to be shared with EFC of the FC model. As an example, consider the case where the feature extractor EFSL of the FSL model has the same or similar architecture as that of a CNN which the FC model is implemented as, the shared parameters may include, but not limited to, one or more of convolutional kernels chosen by EFSL of the trained FSL model. The EFC of the FC model may then adopt the shared parameters in an appropriate way.

In some embodiments, a momentum-based parameter sharing process is implemented, where one or more parameters of EFC of the FC model can be updated with the following equation:

θₜ^{FC}=m*θₜ₋₁^{FC}+(1−m)*θₜ^{FSL} (Equation 2)

where θₜ₋₁^{FC} is the old feature extractor parameter of the FC model, θₜ^{FSL} is the feature extractor parameter of the FSL model that has just been trained in the current iteration, and θₜ^{FC} is the updated feature extractor parameter of the FC model, wherein m is a hyper-parameter named momentum which controls a ratio of each of the shared parameters of EFSL to be adopted by EFC of the FC model, wherein m is a real number and 1≥m≥0.

It should be noted that, the value of the momentum m used in the parameter sharing process for the current iteration may or may not be the same as that used in the previous iteration. As an example, the value of the momentum m may be adjusted for the current iteration, depending on comparison of the performance scores evaluated for the FSL model and the FC model in the performance evaluation stage 520 of the previous iteration. Moreover, it could be readily appreciated that other parameter sharing algorithms are also possible to update parameters of EFC of the FC model, by using the shared parameters of EFSL of the well-trained FSL model.

Further, after the parameters of EFSL of the FSL model being shared with EFC of the FC model, a fine-tuning action may be performed on the FC model to further optimize its performance, according to some embodiments of the disclosure.

With the parameter sharing process discussed herein, the feature extractor of the FC model can acquire information from the well-trained FSL model, and thus may demonstrate similar performance as that of the FSL model especially at an earlier phase where the available data volume is low, without having to learn from scratch, thus reducing much computation cost.

Although the above discussions are made in which the FC model acquires parameter information from the FSL model, it should be noted that if needed, the FC model can also share its feature extractor parameters with the FSL model, by using a variant of Equation 2 discussed above, according to some embodiments of the disclosure.

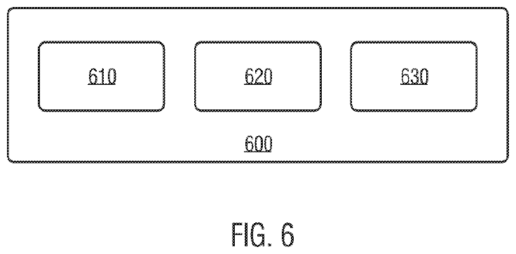

FIG. 6 is a block diagram of an exemplary apparatus 600 incorporating teachings of the present disclosure. The apparatus 600 can be used for enhancing performance of a machine learning classification task. As illustrated, the apparatus 600 may comprise a module 610 which is configured to obtain a first prediction outputted by a first ML classification model which is provided with production data as the input, wherein the first ML classification model is a few-shot learning model having a first feature extractor followed by a metric-based classifier. The apparatus 600 may further comprise a module 620 which is configured to obtain a second prediction outputted by a second ML classification model which is provided with the production data as the input, wherein the second ML classification model has a second feature extractor followed by a fully-connected classifier. And further, the apparatus 600 may comprise a module 630 which is configured to determine a prediction result for the production data by calculating a weighted sum of the first prediction and the second prediction based on weights for the first ML classification model and the second ML classification model.

The exemplary apparatus 600 may be implemented by software, hardware, firmware, or any combination thereof. It could be appreciated that although the apparatus 600 is illustrated to contain module 610-630, more or less modules may be included in the apparatus. For example, one or more of the modules 610-630 illustrated in FIG. 6 may be separated into different modules each to perform at least a portion of the various operations described herein. For example, one or more of the modules 610-630 illustrated in FIG. 6 may be combined, rather than operating as separate modules. For example, the apparatus 600 may comprise other modules configured to perform other actions that have been described in the description.

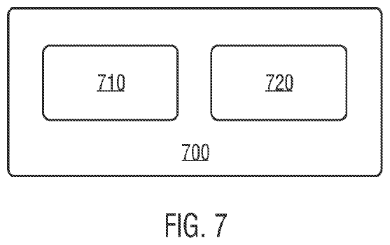

Turning now to FIG. 7, a block diagram of an exemplary computing device 700 incorporating teachings of the present disclosure is illustrated. The computing device 700 can be used for enhancing performance of a machine learning classification task. As illustrated herein, the computing device 700 may comprise one or more processing units 710 and memory 720.

The one or more processing units 710 may include any type of general-purpose processing units/cores (for example, but not limited to CPU, GPU), or application-specific processing units, cores, circuits, controllers or the like. The memory 720 may include any type of medium that may be used to store data. The memory 720 is configured to store instructions that, when executed by the one or more processing units 710, cause the one or more processing units 710 to perform operations of any method described herein, e.g., the exemplary method 300.

In some embodiments, the computing device 700 may further be coupled to or comprise one or more peripherals including but not limited to a display, a speaker, a mouse, a keyboard, and the like. Further, according to some embodiments, the computing device may be equipped with one or more communication interfaces, which can support various types of wired/wireless protocols, to enable communication with a communication network. Examples of the communication network may include but not limited to local area network (LAN), metropolitan area network (MAN), wide area network (WAN), public telephone network, Internet, intranet, Internet of Things, infrared network, Bluetooth network, near field communication (NFC) network, ZigBee network, and etc.

In some embodiments, the above and other components can communicate with each other via one or more buses/interconnects which may support any of suitable bus/interconnect protocols, including but not limited to Peripheral Component Interconnect (PCI), PCI Express, Universal Serial Bus (USB), Serial Attached SCSI (SAS), Serial ATA (SATA), Fiber Channel (FC), System Management Bus (SMBus), and etc.

In some embodiments, the computing device 700 may be coupled to an imaging device to obtain image data captured by the imaging system. In some embodiments, the image data may be retrieved from a database or storage for storing images coupled to the computing device 700.

Various embodiments described herein may include, or may operate on, a number of components, elements, units, modules, instances, or mechanisms, which may be implemented using hardware, software, firmware, or any combination thereof. Examples of hardware may include, but not be limited to, devices, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor devices, chips, microchips, chip sets, and so forth. Examples of software may include, but not be limited to, software components, programs, applications, computer programs, application programs, system programs, machine programs, operating system software, middleware, software modules, routines, subroutines, functions, methods, procedures, software interfaces, application programming interfaces (API), instruction sets, computer code, computer code segments, words, values, symbols, or any combination thereof. Determining whether an embodiment is implemented using hardware, software and/or firmware may vary in accordance with any number of factors, such as desired computational rate, power levels, heat tolerances, processing cycle budget, input data rates, output data rates, memory resources, data bus speeds and other design or performance constraints, as desired for a given embodiment.

Some embodiments described herein may comprise an article of manufacture. An article of manufacture may comprise a storage medium. Examples of storage medium may include volatile and nonvolatile, removable and non-removable media implemented in any method or technology for storage of information, such as computer readable instructions, data structures, program modules, or other data. Storage medium may include, but not be limited to, random-access memory (RAM), read-only memory (ROM), programmable read-only memory (PROM), erasable programmable read-only memory (EPROM), electrically erasable programmable read-only memory (EEPROM), flash memory or other memory technology, compact disc (CD), digital versatile disk (DVD) or other optical storage, magnetic cassette, magnetic tape, magnetic disk storage or other magnetic storage devices, or any other medium which can be used to store information. In some embodiments, an article of manufacture may store executable computer program instructions that, when executed by one or more processing units, cause the processing units to perform operations described herein. The executable computer program instructions may include any suitable type of code, such as source code, compiled code, interpreted code, executable code, static code, dynamic code, and the like. The executable computer program instructions may be implemented using any suitable high-level, low-level, object-oriented, visual, compiled and/or interpreted programming language.

Some examples of the present disclosure described herein are given below. Example 1 may include a method for enhancing performance of a machine learning classification task. The method comprises: obtaining a first prediction outputted by a first machine learning (ML) classification model which is provided with production data as the input, wherein the first ML classification model is a few-shot learning model having a first feature extractor followed by a metric-based classifier; obtaining a second prediction outputted by a second ML classification model which is provided with the production data as the input, wherein the second ML classification model has a second feature extractor followed by a fully-connected classifier; and determining a prediction result for the production data by calculating a weighted sum of the first prediction and the second prediction based on weights for the first ML classification model and the second ML classification model.

Example 2 may include the subject matter of Example 1, wherein the weights for the first ML classification model and the second ML classification model are each determined based on a performance score for the first ML classification model and a performance score for the second ML classification model that are both evaluated using the same set of test data.

Example 3 may include the subject matter of Example 2, wherein in determining of the weights for the first ML classification model and the second ML classification model, a hyper-parameter is used to control amplifying rate of difference between the performance score for the first ML classification model and the performance score for the second ML classification model.

Example 4 may include the subject matter of Example 1, wherein one or more parameters of the first feature extractor of the first ML classification model are to be shared with the second feature extractor of the second ML classification model, after training of the first ML classification model.

Example 5 may include the subject matter of Example 4, wherein a momentum is used to control a ratio of each of the shared parameters of the first feature extractor of the trained first ML classification model to be adopted by the second feature extractor of the second ML classification model.

Example 6 may include the subject matter of Example 4, wherein a fine tuning action is to be performed on the second ML classification model, after the one or more parameters of the first feature extractor of the first ML classification model are shared with the second feature extractor of the second ML classification model.

Example 7 may include the subject matter of Example 4, wherein the first ML classification model is trained on a regular basis in an incremental manner, and wherein the production data comprises image data.

Example 8 may include a computing device. The computing device comprises: memory for storing instructions; and one or more processing units coupled to the memory, wherein the instructions, when executed by the one or more processing units, cause the one or more processing units to: obtain a first prediction outputted by a first machine learning (ML) classification model which is provided with production data as the input, wherein the first ML classification model is a few-shot learning model having a first feature extractor followed by a metric-based classifier; obtain a second prediction outputted by a second ML classification model which is provided with the production data as the input, wherein the second ML classification model has a second feature extractor followed by a fully-connected classifier; and determine a prediction result for the production data by calculating a weighted sum of the first prediction and the second prediction based on weights for the first ML classification model and the second ML classification model.

Example 9 may include the subject matter of Example 8, wherein the weights for the first ML classification model and the second ML classification model are each determined based on a performance score for the first ML classification model and a performance score for the second ML classification model that are both evaluated using the same set of test data.

Example 10 may include the subject matter of Example 9, wherein in determining of the weights for the first ML classification model and the second ML classification model, a hyper-parameter is used to control amplifying rate of difference between the performance score for the first ML classification model and the performance score for the second ML classification model.

Example 11 may include the subject matter of Example 8, wherein one or more parameters of the first feature extractor of the first ML classification model are to be shared with the second feature extractor of the second ML classification model, after training of the first ML classification model.

Example 12 may include the subject matter of Example 11, wherein a momentum is used to control a ratio of each of the shared parameters of the first feature extractor of the trained first ML classification model to be adopted by the second feature extractor of the second ML classification model.

Example 13 may include the subject matter of Example 11, wherein a fine tuning action is to be performed on the second ML classification model, after the one or more parameters of the first feature extractor of the first ML classification model are shared with the second feature extractor of the second ML classification model.

Example 14 may include the subject matter of Example 11, wherein the first ML classification model is trained on a regular basis in an incremental manner, and wherein the production data comprises image data.

Example 15 may include a non-transitory computer-readable storage medium. The medium has stored thereon instructions that, when executed on one or more processing units, cause the one or more processing units to: obtain a first prediction outputted by a first machine learning (ML) classification model which is provided with production data as the input, wherein the first ML classification model is a few-shot learning model having a first feature extractor followed by a metric-based classifier; obtain a second prediction outputted by a second ML classification model which is provided with the production data as the input, wherein the second ML classification model has a second feature extractor followed by a fully-connected classifier; and determine a prediction result for the production data by calculating a weighted sum of the first prediction and the second prediction based on weights for the first ML classification model and the second ML classification model.

Example 16 may include the subject matter of Example 15, wherein the weights for the first ML classification model and the second ML classification model are each determined based on a performance score for the first ML classification model and a performance score for the second ML classification model that are both evaluated using the same set of test data.

Example 17 may include the subject matter of Example 16, wherein in determining of the weights for the first ML classification model and the second ML classification model, a hyper-parameter is used to control amplifying rate of difference between the performance score for the first ML classification model and the performance score for the second ML classification model.

Example 18 may include the subject matter of Example 15, wherein one or more parameters of the first feature extractor of the first ML classification model are to be shared with the second feature extractor of the second ML classification model, after training of the first ML classification model.

Example 19 may include the subject matter of Example 18, wherein a momentum is used to control a ratio of each of the shared parameters of the first feature extractor of the trained first ML classification model to be adopted by the second feature extractor of the second ML classification model.

Example 20 may include the subject matter of Example 18, wherein a fine tuning action is to be performed on the second ML classification model, after the one or more parameters of the first feature extractor of the trained first ML classification model are shared with the second feature extractor of the second ML classification model.

Example 21 may include the subject matter of Example 18, wherein the first ML classification model is trained on a regular basis in an incremental manner, and wherein the production data comprises image data.

Example 22 may include an apparatus for enhancing performance of a machine learning classification task. The apparatus comprises: means for obtaining a first prediction outputted by a first machine learning (ML) classification model which is provided with production data as the input, wherein the first ML classification model is a few-shot learning model having a first feature extractor followed by a metric-based classifier; means for obtaining a second prediction outputted by a second ML classification model which is provided with the production data as the input, wherein the second ML classification model has a second feature extractor followed by a fully-connected classifier; and means for determining a prediction result for the production data by calculating a weighted sum of the first prediction and the second prediction based on weights for the first ML classification model and the second ML classification model.

Example 23 may include the subject matter of Example 22, wherein the weights for the first ML classification model and the second ML classification model are each determined based on a performance score for the first ML classification model and a performance score for the second ML classification model that are both evaluated using the same set of test data.

Example 24 may include the subject matter of Example 23, wherein in determining of the weights for the first ML classification model and the second ML classification model, a hyper-parameter is used to control amplifying rate of difference between the performance score for the first ML classification model and the performance score for the second ML classification model.

Example 25 may include the subject matter of Example 22, wherein one or more parameters of the first feature extractor of the first ML classification model are to be shared with the second feature extractor of the second ML classification model, after training of the first ML classification model.

Example 26 may include the subject matter of Example 25, wherein a momentum is used to control a ratio of each of the shared parameters of the first feature extractor of the trained first ML classification model to be adopted by the second feature extractor of the second ML classification model.

Example 27 may include the subject matter of Example 25, wherein a fine tuning action is to be performed on the second ML classification model, after the one or more parameters of the first feature extractor of the trained first ML classification model are shared with the second feature extractor of the second ML classification model.

Example 28 may include the subject matter of Example 25, wherein the first ML classification model is trained on a regular basis in an incremental manner, and wherein the production data comprises image data.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A method for enhancing performance of a machine learning (ML) classification task, the method comprising:
obtaining a first prediction generated by a first machine learning classification model provided with production data as input, wherein the first ML classification model comprise a few-shot learning model having a first feature extractor followed by a metric-based classifier;
obtaining a second prediction generated by a second ML classification model provided with the production data as input, wherein the second ML classification model has a second feature extractor followed by a fully-connected classifier; and
determining a prediction result for the production data by calculating a weighted sum of the first prediction and the second prediction based on weights for the first ML classification model and the second ML classification model.

2. The method of claim 1, wherein the weights for the first ML classification model and the weights for the second ML classification model are each determined based on a respective performance score for the respective classification model evaluated using a single set of test data.

3. The method of claim 2, wherein determining the respective weights for the first ML classification model and the second ML classification model includes using a hyper-parameter to control amplifying rate of difference between the performance score for the first ML classification model and the performance score for the second ML classification model.

4. The method of claim 1, further comprising sharing one or more parameters of the first feature extractor of the first ML classification model with the second feature extractor of the second ML classification model after training the first ML classification model.

5. The method of claim 4, further comprising using to control a ratio of each of the shared parameters of the first feature extractor of the trained first ML classification model to be adopted by the second feature extractor of the second ML classification model.

6. The method of claim 4, further comprising performing a fine tuning action on the second ML classification model after the one or more parameters of the first feature extractor of the trained first ML classification model are shared with the second feature extractor of the second ML classification model.

7. The method of claim 4, further comprising training the first ML classification model on a regular basis in an incremental manner; and
wherein the production data comprises image data.

8. A computing device comprising:
memory for storing instructions; and
one or more processing units coupled to the memory;
wherein the instructions, when executed by the one or more processing units, cause the one or more processing units to:
obtain a first prediction generated by a first machine learning (ML) classification model provided with production data as input, wherein the first ML classification model comprises a few-shot learning model having a first feature extractor followed by a metric-based classifier;
obtain a second prediction generated by a second ML classification model provided with the production data as input, wherein the second ML classification model has a second feature extractor followed by a fully-connected classifier; and
determine a prediction result for the production data by calculating a weighted sum of the first prediction and the second prediction based on respective weights for the first ML classification model and the second ML classification model.

9. The computing device of claim 8, wherein the weights for the first ML classification model and the second ML classification model depend on a respective performance score for the first ML classification model and a respective performance score for the second ML classification model both evaluated using the a single set of test data.

10. The computing device of claim 9, wherein determining the weights for the first ML classification model and the second ML classification model includes using a hyper-parameter to control amplifying rate of difference between the performance score for the first ML classification model and the performance score for the second ML classification model.

11. The computing device of claim 8, wherein one or more parameters of the first feature extractor of the first ML classification model are to be shared with the second feature extractor of the second ML classification model after training of the first ML classification model.

12. The computing device of claim 11, wherein a momentum is used to control a ratio of each of the shared parameters of the first feature extractor of the trained first ML classification model to be adopted by the second feature extractor of the second ML classification model.

13. The computing device of claim 11, wherein a fine tuning action is to be performed on the second ML classification model, after the one or more parameters of the first feature extractor of the trained first ML classification model are shared with the second feature extractor of the second ML classification model.

14. The computing device of claim 11, wherein the first ML classification model is trained on a regular basis in an incremental manner, and wherein the production data comprises image data.

15. A non-transitory computer-readable storage medium having stored thereon instructions that, when executed on one or more processing units, cause the one or more processing units to:
obtain a first prediction generated by a first machine learning (ML) classification model provided with production data as input, wherein the first ML classification model comprises a few-shot learning model having a first feature extractor followed by a metric-based classifier;
obtain a second prediction generated by a second ML classification model provided with the production data as input, wherein the second ML classification model has a second feature extractor followed by a fully-connected classifier; and
determine a prediction result for the production data by calculating a weighted sum of the first prediction and the second prediction based on respective weights for the first ML classification model and the second ML classification model.

16. The non-transitory computer-readable storage medium of claim 15, wherein the weights for the first ML classification model and the second ML classification model are each determined based on a performance score for the first ML classification model and a performance score for the second ML classification model both evaluated using a single set of test data.

17. The non-transitory computer-readable storage medium of claim 16, wherein determining of the weights for the first ML classification model and the second ML classification model includes using a hyper-parameter to control amplifying rate of difference between the performance score for the first ML classification model and the performance score for the second ML classification model.

18. The non-transitory computer-readable storage medium of claim 15, wherein one or more parameters of the first feature extractor of the first ML classification model are to be shared with the second feature extractor of the second ML classification model after training of the first ML classification model.

19. The non-transitory computer-readable storage medium of claim 18, wherein a momentum is used to control a ratio of each of the shared parameters of the first feature extractor of the shared first ML classification model to be adopted by the second feature extractor of the second ML classification model.

20. (canceled)
